(19) United States
(12) Patent Application Publication
(10) Pub. No.: US 2018/0150804 A1
(43) Pub. Date: May 31, 2018

(54) Computerized Maintenance Management System With Fraud Detection Analytics

(71) Applicant: Certan Health Inc., Lakewood, CA (US)

(72) Inventor: Andre Lauren Clark, SR., Lakewood, CA (US)

(21) Appl. No.: 15/352,741

(22) Filed: Nov. 28, 2016

(51) Int. Cl. G06Q 10/00; G06Q 10/06

(52) U.S. Cl. CPC G06Q 10/20; G06Q 10/063116; G06Q 10/063114

(57) ABSTRACT

Disclosed herein are system, method, and computer program product embodiments for utilizing non-RAM memory to implement a cache. A computerized maintenance management system transmits, to a first client device, a work order comprising an identification of a device for maintenance and a list of tasks associated with the work order. The system receives, from the first client device, an identifier associated with a service provider, a servicing time associated with the work order, and completion statuses associated with tasks of the list of tasks. The system stores the servicing time and the completion statuses and determines, based on an analysis of the servicing time, a likelihood that the one or more of the completion statuses were misstated. The system transmits, to a second client device, information associated with the work order based on the determined likelihood that the one or more completion statuses were misstated.

### BACKGROUND

### Technical Field

Embodiments generally relate to computerized maintenance management systems.

### Background

Computerized maintenance management systems (CMMS) are software packages for maintaining one or more databases with information about an organization's equipment maintenance operations. Large organizations, such as, for example, hospitals, manufacturing facilities, offices, etc., may need to perform maintenance on a large numbers of equipment on a tight schedule. For example, hospitals may be required by law to perform certain preventive maintenance to their medical equipment on a regular basis, and may receive fines if maintenance is not performed on schedule. CMMSs may be used to keep track of maintenance schedules, generate work orders for maintenance tasks, record maintenance task details, track maintenance completion, and generally log all maintenance work in an organization.

### BRIEF DESCRIPTION OF THE DRAWINGS

The accompanying drawings are incorporated herein and form a part of the specification.

FIG. 1 illustrates a computerized maintenance management system (CMMS) environment, according to an example embodiment.

FIG. 2 illustrates a technician graphical user interface for accessing work orders in a CMMS, according to an example embodiment.

FIG. 3 illustrates a work order interface for completing a work order, according to an example embodiment.

FIG. 4 illustrates an administrator interface for visualizing statistics associated with device maintenance, according to an example embodiment.

FIG. 5 shows an administrator interface for entering device information into a CMMS, according to an example embodiment.

FIG. 6 shows an administrator interface illustrating data and statistics for maintenance performed on a device, according to an example embodiment.

FIG. 7 shows an administrator interface illustrating data and statistics for maintenance performed on a device and adjustment of a baseline value, according to an example embodiment.

FIG. 8 is a flowchart for a method for detecting potentially fraudulent maintenance activity in a computerized maintenance management system, according to an example embodiment.

FIG. 9 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for detecting potentially fraudulent maintenance activity in a computerized maintenance management system (CMMS).

While the embodiments described herein are exemplified in the context of a CMMS system for a hospital, they are generally applicable to any CMMS that tracks equipment maintenance in any type of organization.

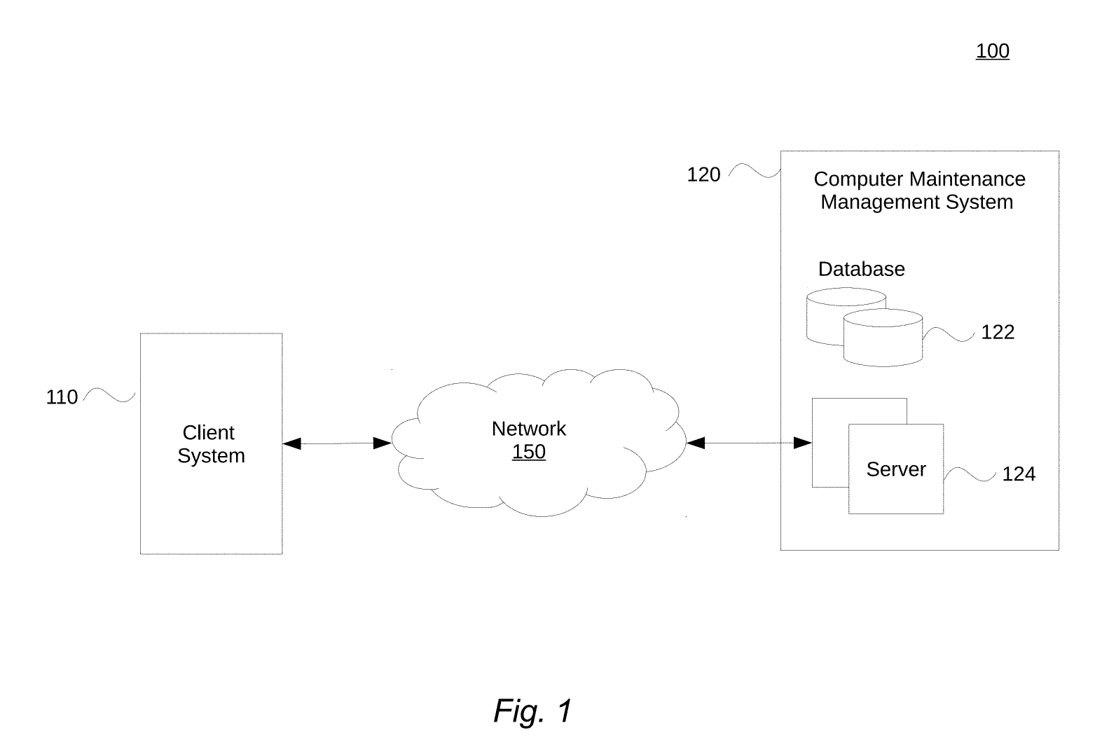

FIG. 1 illustrates a CMMS environment 100, according to an example embodiment. A client system 110 connects to a CMMS 120 through a network 150. The network may be any communications network suitable for transmitting data between computing devices, such as, by way of example, a Local Area Network (LAN), a Wide Area Network (WAN), Metropolitan Area Network (MAN), Personal Area Network (PAN), the Internet, wireless networks, satellite networks, overlay networks, or any combination thereof. Client system 110 may be any computing device suitable for interacting with a CMMS, such as, by way of example, a personal computer, mobile computer, laptop computer, mobile phone, smartphone, personal digital assistant, or tablet computer. CMMS 120 may be any computing device or combination of devices suitable to provide information management services, such as, by way of example, server computers, database systems, storage area networks, web servers, application servers, or any combination thereof.

CMMS 120 may maintain maintenance management information for any type of organization, such as, for example, a hospital, a manufacturing plant, an office, an apartment complex, etc. A user of client system 110 (e.g., a technician, such as a Biomedical Equipment Technician) may interact with CMMS 120 through any suitable interface, such as, by way of example, an application, web browser, web application, mobile application, etc. Multiple users of CMMS 120 may use client systems 110 to view and enter information associated with equipment and maintenance. One or more servers 124 may provide one or more the user interfaces through network 150. For example, a technician may access CMMS 120 through a technician interface for accessing service work orders and logging the completion of service work orders. An administrator of CMMS 120 may access CMMS 120 through an administrator interface that displays information about the status of work orders, allows management and scheduling of work orders, and displays statistics or analytics on device maintenance. Through CMMS 120, devices may be automatically scheduled for preventive or routine maintenance at specified intervals, for example as determined by regulations or manufacturer's guidelines.

CMMS 120 may maintain one or more databases 122 to store information about devices, work orders, and users. Databases 122 may maintain information associated with users, including by way of example, user account information, user authentication credentials information, user type (e.g., technician, administrator, etc.), and general user information (e.g., name, company, job title, technical specialty, etc.).

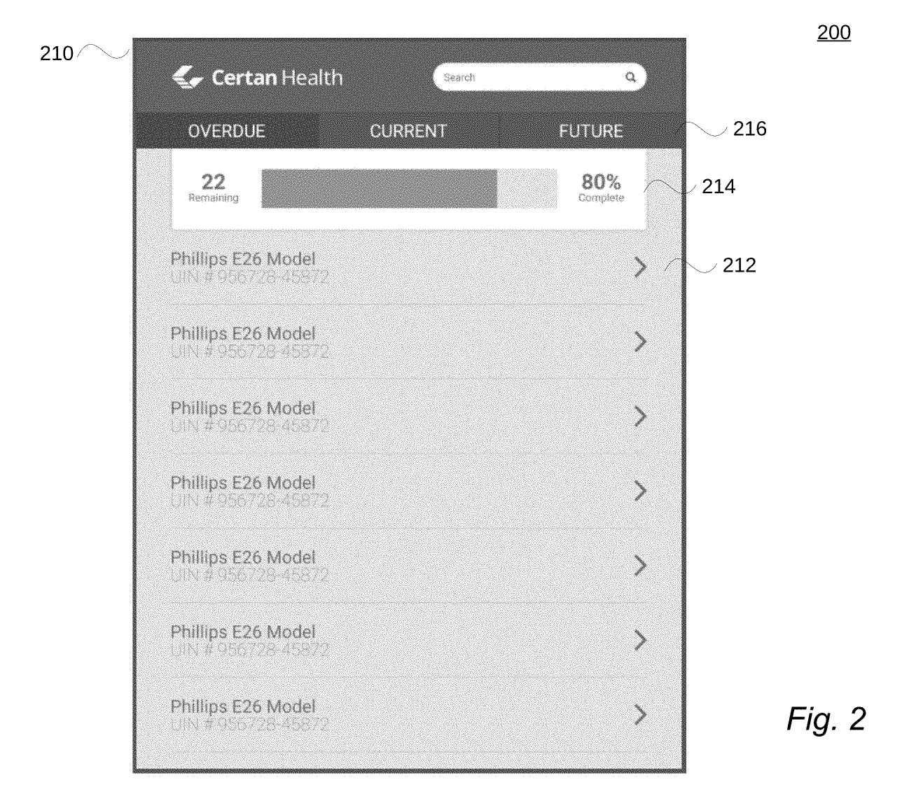

FIG. 2 illustrates a technician graphical user interface 200 for accessing work orders in a CMMS 120, according to an example embodiment. In particular embodiments, CMMS 120 may provide a user interface to client 110 displaying the work orders for completion for the technician. As an example, a technician using a client 110 may login to CMMS 120 using authentication credentials (e.g., username and password) and be able to view a list of work orders to be completed by a particular deadline (e.g., day, week, month, etc.). As an example, the list may be of devices that need to be serviced by the end of the day. As an example, in a hospital setting, a list may include an x-ray machine, a sonogram machine, an Mill machine, etc.

In an embodiment, each work order is assigned to a particular user. In another embodiment, the work orders may be available for any technician to accept. In particular embodiments, the user may select one of the work orders and may be redirected to an interface showing the details of the work order. In the example shown, the interface may include a completion progress bar 214 indicating the user's progress towards completing the work orders assigned. Also, the user may be able to browse work orders by their status, such as overdue work orders, work orders due soon, and work orders due at a later time in the future, as illustrated by element 216.

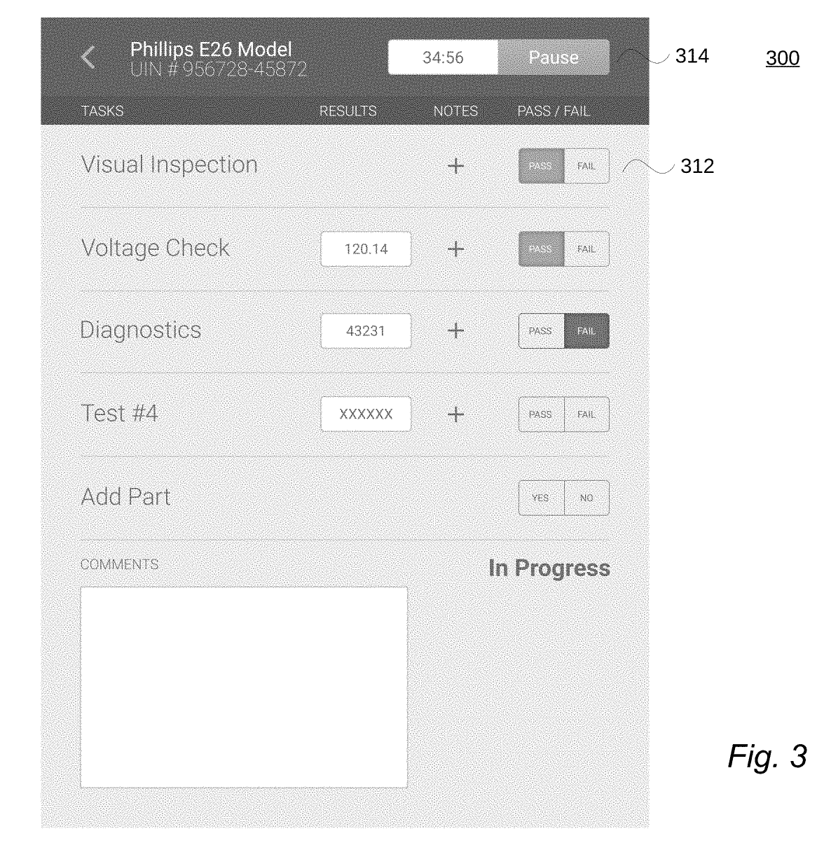

FIG. 3 illustrates a work order interface 300 for completing a work order, according to an example embodiment. In particular embodiments, the interface may include one or more tasks 312 corresponding to the work order. In particular embodiments, the CMMS may require the user to complete some or all tasks in order to complete the work order. In the example shown, the CMMS may allow the user to mark the status of each task such as, for example, PASS or FAIL. The interface may also allow the user to provide a comment with details on the maintenance performed or a reason why the maintenance was not completed (e.g., “Completed diagnostics, but need replacement part to complete order.”)

In particular embodiments, interface 300 may include a portion 314 displaying a time since the user started performing work on the work order. In an embodiment, the timer starts running when the user enters the work order interface. In an embodiment, the user signals that she is starting to perform work on the work order to initiate the timer.

In particular embodiments, CMMS 120 may keep track of the time users spend performing particular work orders and tasks, and uses this information to determine the likelihood that the users are committing maintenance fraud. For example, a technician committing maintenance fraud may input on the work order interface that she has completed the work order without actually performing any work, thus misstating the work order completion status. In particular embodiments, client device 110 may transmit to CMMS 120 the amount of time that the user spent working on each particular task, as well as the total time until the user completed or finished working on the work order. CMMS 120 may store this data associated with the user to perform analytics and fraud detection. For example, CMMS may compare the time a user spent on a work order for a device to a baseline time that maintenance on that device should take. If the difference between the times is large enough, the CMMS may raise a flag or alert for the administrators. As an example, a technician may open a work order for preventive maintenance on an X-ray machine and indicate completion of the order 5 minutes later. CMMS 120 may receive this servicing time information and compare it to a baseline time for performing preventive maintenance on the X-ray machine. For example, if the baseline time for the preventive maintenance on the X-ray machine is 45 minutes, but the technician opened and closed the work order in 5 minutes, CMMS 120 may raise a flag indicating that there is a high likelihood that the technician did not really perform the required maintenance work, and that the completion of the work order was fraudulently misstated by the user. In particular embodiments, CMMS 120 may in addition or alternatively compare the servicing time information for individual tasks within a work order with a corresponding baseline time. For example, when the user marks a particular task as completed (e.g., indicating “PASS,” “FAIL,” “COMPLETED,” etc.), the client device 110 transmits the corresponding time to CMMS 120. While the transmission of completion times for tasks and work orders and determination of the likelihood of fraudulent activity are described in a particular manner, this disclosure contemplates the transmission of completion times for tasks and work orders and determination of the likelihood of fraudulent activity in any suitable manner.

In particular embodiments, CMMS 120 may determine that a user is likely misstating a maintenance status when the difference between the servicing time received from the client device and the baseline time for the task or order is below a configurable threshold (e.g., a tolerance value). In particular embodiments, the likelihood is determined when the difference in time is above or below a configurable percentage of the baseline time (e.g., a tolerance percentage). As an example, if the reported servicing time is 20% lower than the baseline time, CMMS 120 may determine there is a high likelihood of misstatement and record it as an “incident”, otherwise a lower likelihood. In an embodiment, the determined likelihood is measured as a continuous probability.

In particular embodiments, CMMS 120 may further analyze the servicing times to determine the different manners of misstatement that may have been made by technician users. In particular embodiments, CMMS 120 measures duration incidents and form incidents. A duration incident may be recorded when a servicing time for a work order is less than a threshold portion of the baseline servicing time for the work order, as described in the above examples. A form incident may be recorded based on an analysis for the times between task completions, between task and work order completion, or any combination thereof. For example, a form incident may be recorded when a servicing time for a work order is within the threshold portion of the baseline servicing time, but there is a large discrepancy in servicing times for the tasks within that work order. As an example, a technician may open a work order and leave it open for extended amount of time without performing any work. When a sufficient amount of time has passed for the technician to feel she will not be suspected of fraud, the technician may then quickly check off all the tasks as completed and finalize the work order. In such a scenario, the first task's servicing time may be a very large portion of the total time, and the servicing time for the rest of the tasks may be much shorter short. For example, a technician may know that servicing an X-ray machine typically takes 45 minutes and comprises 4 tasks (e.g., checking voltage, changing fluids, cleaning rollers, and testing). She may open the work order and leave it open for 45 minutes. After the 45 minutes have passed, the technician may check off all the tasks as completed, and submit the work order as completed. Thus, CMMS 120 may receive that the first task (checking voltage) took 45 minutes to complete, and the rest took 1 second each. In this scenario, CMMS 120 may record a form incident, since the servicing times of the tasks are disproportionate.

In particular embodiments, CMMS 120 may record a form incident when the amount of time between the last task being marked as completed and the work order being closed exceeds a threshold. In particular embodiments, CMMS 120 may record a form incident when the amount of time between the first task being marked as completed and the last task being marked as completed is less than a threshold. In particular embodiments, CMMS 120 may record a form incident when one or more tasks are completed in less than a threshold time (e.g., 30 seconds). In particular embodiments, CMMS 120 may record a form incident when the first task servicing time exceeds a threshold amount of the total servicing time for the work order (e.g., 99%). In particular embodiments, CMMS 120 may compare each task servicing time with baseline times for each task, and record a form incident when the value or percentage difference is below a threshold. In particular embodiments, the CMMS may record a form incident when the variance or standard deviation between task servicing times s a threshold. While particular manners of recording a form incident are described, this disclosure contemplates recording a form incident in any suitable manner.

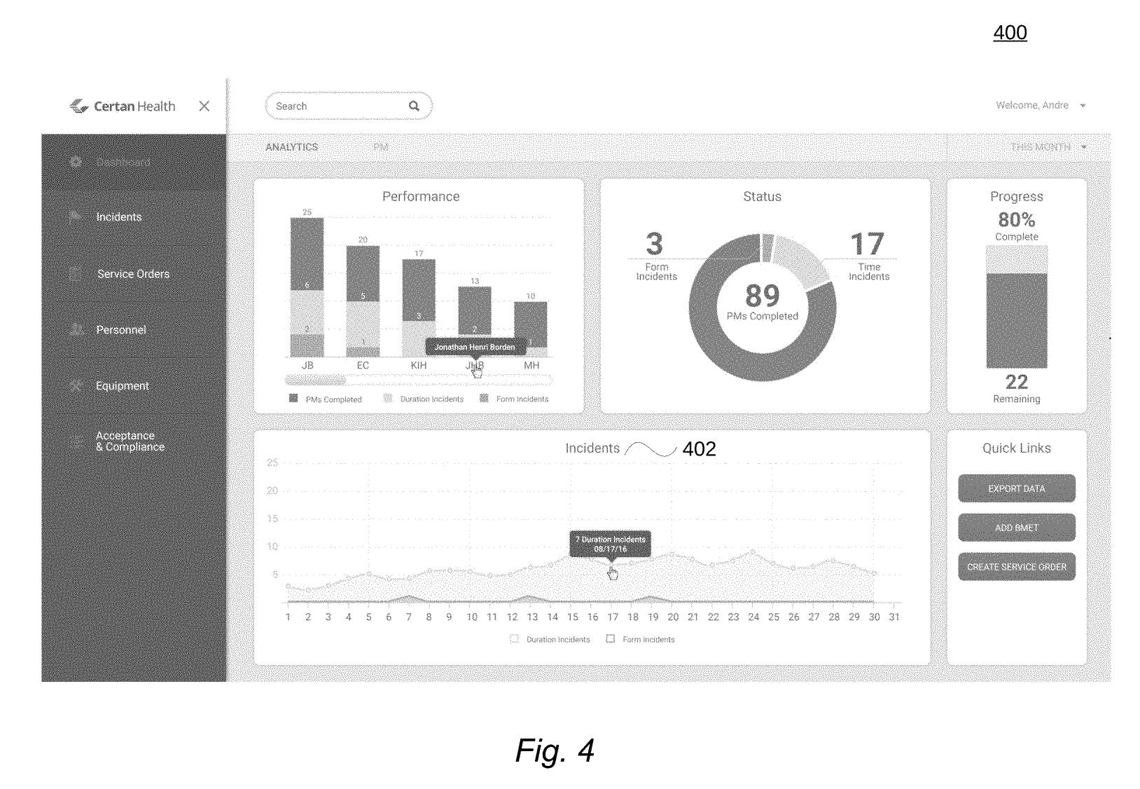

FIG. 4 illustrates an administrator interface 400 for visualizing statistics associated with device maintenance, according to an example embodiment. Administrator type users may login to administrator interface 400 (e.g., using a username and password) to manage the maintenance of devices in an organization. The administrator interface may include a portion 402 that illustrates incidents of potential maintenance fraud in the organization. In particular embodiments, a graph illustrates the incidents of different types and their occurrences over time. In this manner, an administrator can visualize patterns, and detect any unusual or suspicious activity. While the visualization of incidents is described in a particular manner, this disclosure contemplates the visualization of incidents in any suitable manner.

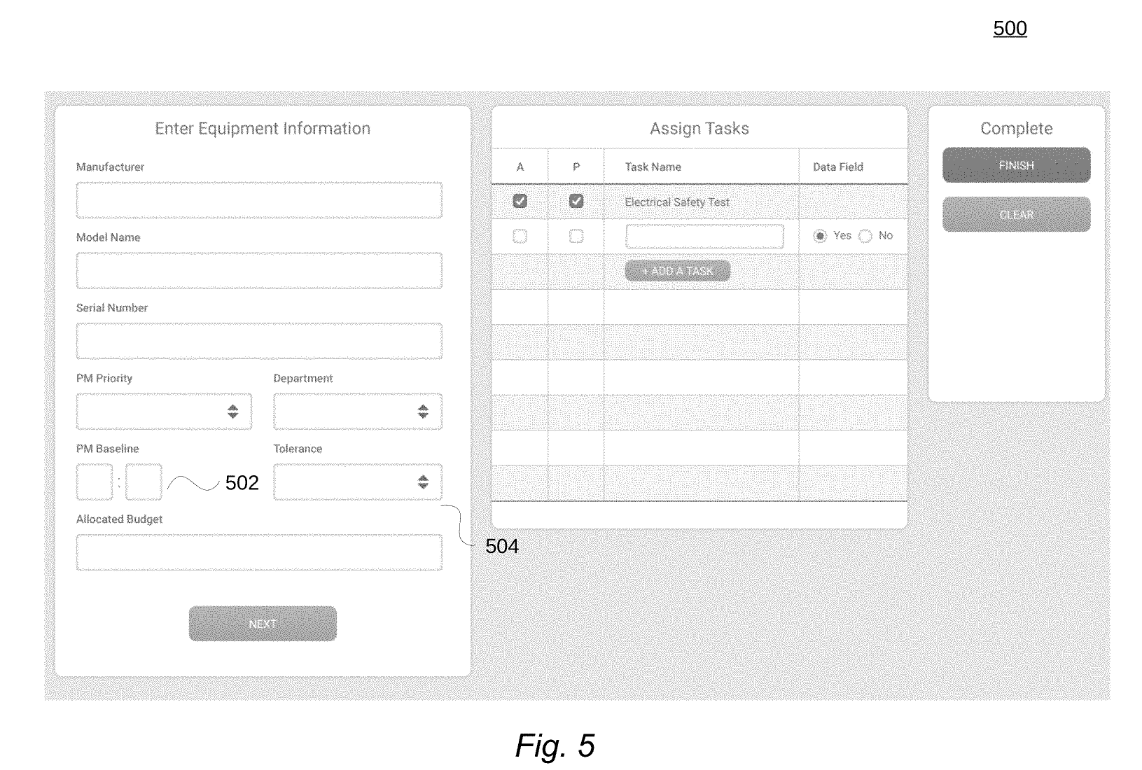

FIG. 5 shows an administrator interface 500 for entering device information into CMMS 120, in an example embodiment. Interface 500 may provide for entering information about a new or existing device for maintenance, including name, model, serial number, etc. and assign maintenance tasks for maintenance work orders. In particular embodiments, interface 500 may include a portion for the administrator user to specify a baseline servicing time (e.g., Preventive Maintenance Baseline) for performing the work order maintenance on the device. In particular embodiments, interface 500 may also include portions for entering baseline servicing times for particular tasks (not shown). Additionally, interface 500 may include a portion 504 for entering a tolerance associated with the baseline servicing time. In particular embodiments, the tolerance value may represent a percentage that the servicing time a work order associated with the device can deviate from the baseline before raising an incident flag.

In particular embodiments, CMMS 120 may provide functionality to specify and automatically order parts for completing certain device maintenance work orders. For example, an X-ray machine may need rollers replaced every 6 months. In this example, an administrator may create a work order for replacing rollers every 6 months, and specify the roller parts that should be used. CMMS 120 may then automatically order the parts a specified amount of time before the work order is due (e.g., 15 days prior). In particular embodiments, certain devices may use batteries that need to be replaced at set intervals. In an embodiment, CMMS 120 may provide a user interface element for specifying that a device is battery powered, setting the battery replacement interval (i.e., how much time before the battery should be replaced), and type of battery used. CMMS 120 may then automatically create work orders for battery replacement at the specified interval and automatically order the battery at a specified amount of time before the replacement work order is due.

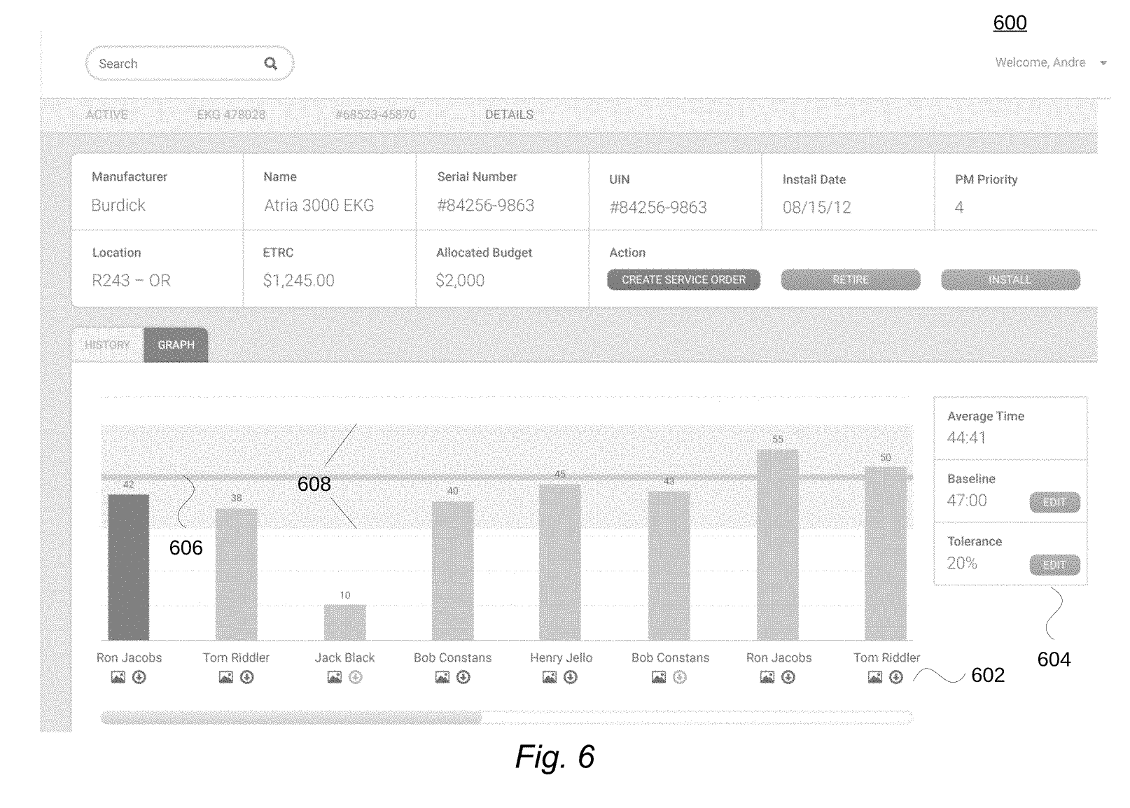

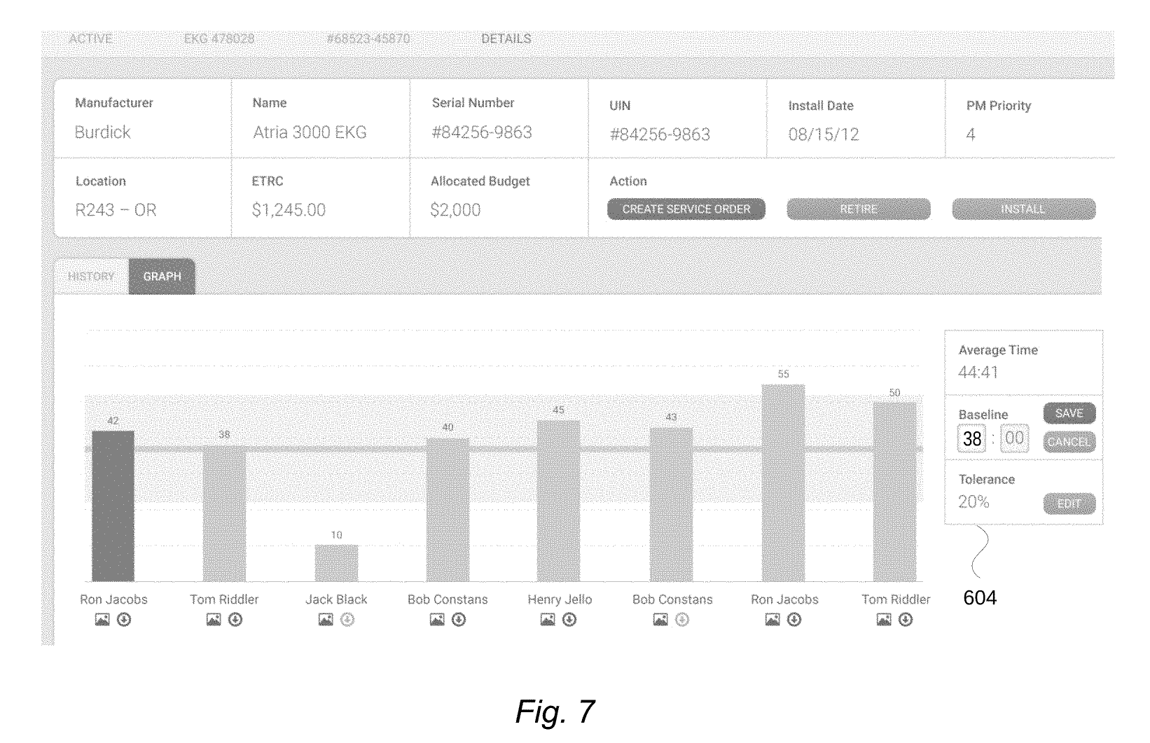

FIG. 6 shows an administrator interface 600 illustrating data and statistics for maintenance performed on a device, according to an example embodiment. In particular embodiments, interface 600 may illustrate statistics for device maintenance performed by one or more service providers. The statistics may indicate an average servicing time for the device by each provider (i.e., how long each provider has taken on average to perform maintenance on this device). In the example shown, each provider is shown with a bar graph (602) showing the number of times each provider has performed maintenance on the device, and the servicing time of the maintenance. The example of FIG. 6 also shows the average servicing time across all providers, along with the established baseline servicing time and tolerance (604). In particular embodiments, an administrator user may modify the baseline servicing time and tolerance from interface 600, as shown by the example EDIT buttons in element 604. In the example, the bar graph illustrates the baseline servicing time with a line across the bar graph (606), and the tolerance as an upper and lower banner from the line (608). In this manner, an administrator can visualize the baseline and tolerance with respect to the actual average servicing times of the providers, and thus can visually detect how much particular providers have deviated from the baseline and averages. This may allow administrators to decide whether to readjust the baseline servicing time, or take action to resolve problems with a particular maintenance provider. FIG. 7 illustrates the change in the baseline and tolerance from 47:00 to 38:00 using example interface element 604.

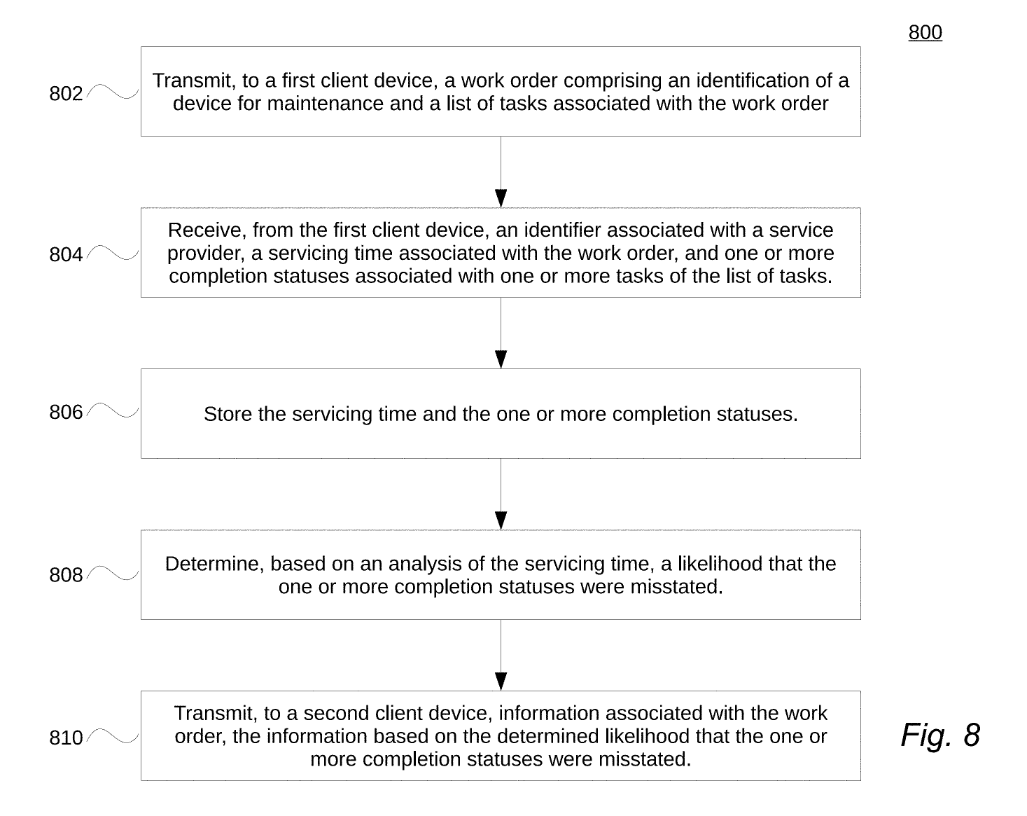

FIG. 8 is a flowchart for a method 800 for detecting potentially fraudulent maintenance activity in a computerized maintenance management system, according to an example embodiment. Method 800 can be performed by processing logic that can comprise hardware (e.g., circuitry, dedicated logic, programmable logic, microcode, etc.), software (e.g., instructions run on a processing device), or a combination thereof.

In step 802, CMMS 120 transmits, to a first client device, a work order comprising an identification of a device for maintenance and a list of tasks associated with the work order. In step 804, CMMS 120 receives, from the first client device, an identifier associated with a service provider, a servicing time associated with the work order, and one or more completion statuses associated with one or more tasks of the list of tasks. In step 806, CMMS 120 stores the servicing time and the one or more completion statuses. In step 808, CMMS 120 determines, based on an analysis of the servicing time, a likelihood that the one or more completion statuses were misstated. In step 810, CMMS transmits, to a second client device, information associated with the work order, the information based on the determined likelihood that the one or more completion statuses were misstated.

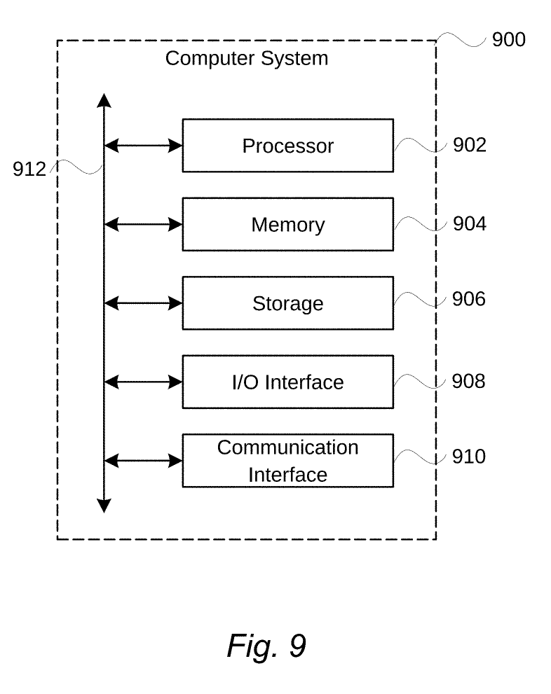

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example, computer system 900 may be an embedded computer system, a desktop computer system, a laptop or notebook computer system, a mainframe, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, memory 904 includes random access memory (RAM). This RAM may be volatile memory, where appropriate Memory 904 may include one or more memories 904, where appropriate. Although this disclosure describes and illustrates particular memory, this disclosure contemplates any suitable memory.

In particular embodiments, storage 906 includes mass storage for data or instructions. As an example, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A computer-implemented method comprising, by at least one processor:
transmitting, to a first client device, a work order comprising an identification of a device for maintenance and a list of tasks associated with the work order;
receiving, from the first client device, an identifier associated with a service provider, a servicing time associated with the work order, and one or more completion statuses associated with one or more tasks of the list of tasks;
storing the servicing time and the one or more completion statuses;
determining, based on an analysis of the servicing time, a likelihood that the one or more of the completion statuses were misstated; and
transmitting, to a second client device, information associated with the work order, the information based on the determined likelihood that the one or more completion statuses were misstated.

2. The method of claim 1, wherein the analysis of the servicing time comprises:
comparing the servicing time with a baseline servicing time associated with the device for maintenance,
wherein the determining the likelihood that one or more completion statuses were misstated is based on a difference between the servicing time and the baseline servicing time.

3. The method of claim 1, further comprising:
receiving, from the first client device, a second servicing time associated at least one of the tasks of the lists of tasks,
wherein the determining a likelihood that one or more completion statuses were misstated is further based on an analysis of the second servicing time.

4. The method of claim 1, wherein the transmitting information associated with the work order comprises transmitting a visualization for display of:
average servicing times for the work order for each of a plurality of service providers, and
an average servicing time for the work order across the plurality of service providers.

5. The method of claim 2, further comprising:
receiving, from the second client device, a request to adjust the baseline servicing time to a new baseline servicing time.

6. The method of claim 2, further comprising:
adjusting the baseline servicing time to a new baseline servicing time based on average servicing times for the work order across a plurality of service providers.

7. The method of claim 1, wherein the device for maintenance is a medical device.

8. A system, comprising:
a memory; and
at least one processor coupled to the memory and configured to:
transmit, to a first client device, a work order comprising an identification of a device for maintenance and a list of tasks associated with the work order;
receive, from the first client device, an identifier associated with a service provider, a servicing time associated with the work order, and one or more completion statuses associated with one or more tasks of the list of tasks;
store the servicing time and the one or more completion statuses;
determine, based on an analysis of the servicing time, a likelihood that the one or more of the completion statuses were misstated; and
transmit, to a second client device, information associated with the work order, the information based on the determined likelihood that the one or more completion statuses were misstated.

9. The system of claim 8, wherein to do the analysis of the servicing time the at least one processor is configured to:
compare the servicing time with a baseline servicing time associated with the device for maintenance,
wherein to determine the likelihood that one or more completion statuses were misstated the processor is configured to compute a difference between the servicing time and the baseline servicing time.

10. The system of claim 8, wherein the processor is further configured:
receive, from the first client device, a second servicing time associated at least one of the tasks of the lists of tasks,
wherein the determining a likelihood that one or more completion statuses were misstated is further based on an analysis of the second servicing time.

11. The system of claim 8, wherein to transmit the information associated with the work order the processor is further configured to transmit a visualization for display of:
average servicing times for the work order for each of a plurality of service providers, and
an average servicing time for the work order across the plurality of service providers.

12. The system of claim 9, wherein the processor is further configured to:
receive, from the second client device, a request to adjust the baseline servicing time to a new baseline servicing time.

13. The system of claim 9, wherein the processor is further configured to:
adjust the baseline servicing time to a new baseline servicing time based on average servicing times for the work order across a plurality of service providers.

14. The system of claim 8, wherein the device for maintenance is a medical device.

15. A tangible computer-readable device having instructions stored thereon that, when executed by at least one computing device, causes the at least one computing device to perform operations comprising:
transmitting, to a first client device, a work order comprising an identification of a device for maintenance and a list of tasks associated with the work order;
receiving, from the first client device, an identifier associated with a service provider, a servicing time associated with the work order, and one or more completion statuses associated with one or more tasks of the list of tasks;
storing the servicing time and the one or more completion statuses;
determining, based on an analysis of the servicing time, a likelihood that the one or more of the completion statuses were misstated; and
transmitting, to a second client device, information associated with the work order, the information based on the determined likelihood that the one or more completion statuses were misstated.

16. The computer-readable medium of claim 15, wherein the analysis of the servicing time comprises:
comparing the servicing time with a baseline servicing time associated with the device for maintenance,
wherein the determining the likelihood that one or more completion statuses were misstated is based on a difference between the servicing time and the baseline servicing time.

17. The computer-readable medium of claim 15, the operations further comprising:
receiving, from the first client device, a second servicing time associated at least one of the tasks of the lists of tasks,
wherein the determining a likelihood that one or more completion statuses were misstated is further based on an analysis of the second servicing time.

18. The computer-readable medium of claim 15, wherein the transmitting information associated with the work order comprises transmitting a visualization for display of:
average servicing times for the work order for each of a plurality of service providers, and
an average servicing time for the work order across the plurality of service providers.

19. The computer-readable medium of claim 16, the operations further comprising:
receiving, from the second client device, a request to adjust the baseline servicing time to a new baseline servicing time.

20. The computer-readable medium of claim 16, the operations further comprising:
adjusting the baseline servicing time to a new baseline servicing time based on average servicing times for the work order across a plurality of service providers.
